(19) United States
(12) Patent Application Publication
(10) Pub. No.: US 2003/0171049 A1
(43) Pub. Date: Sep. 11, 2003

(54) Laminar material, method of making same and shoe insoles including said laminar materials

(76) Inventors: Brian Arnold, Leicester (GB); Susan Gwynneth Johnson, Leicester (GB)

Correspondence Address: Louis Myers, Fish & Richardson, 225 Franklin Street, Boston, MA, 02110-2804, US

(21) Appl. No.: 10/311,145

(22) PCT Filed: Jun. 26, 2001
(86) PCT No.: PCT/GB01/02845

(30) Foreign Application Priority Data
Jun. 27, 2000 (GB) 0015576.2

(51) Int. Cl. B32B 27/12; B32B 5/26; D04H 1/00; D04H 3/00

(52) U.S. Cl. 442/286; 442/239

(57) ABSTRACT

A laminar material suitable for use in the manufacture of shoes comprising an extruded thermoplastic sheet core (10) having laminated thereto on at least one side a first fibre fabric layer (12), wherein the melting point of said first fibre layer (12) is similar to the melting point of the thermoplastic sheet core (10), and the thermoplastic sheet core (10) comprises: (1) recycled scrap laminar material comprising an extruded thermoplastic material having laminated thereto on at least one side a second fibre fabric layer, wherein the melting points of the extruded thermoplastic material and the second fibre fabric layer are similar to the melting point of the first fibre layer (12); or (2) virgin extrudable thermoplastic material having a melting point similar to the melting point of said first fibre layer (12); or (3) a mixture of both of these materials (1) and (2).

This invention is concerned with laminar materials suitable for use in the manufacture of shoes, methods of making the same and shoe components comprising said laminar materials, especially shoe insoles.

The term “shoe” where used herein is intended to denote outer footwear generally whether ready for wear or in the course of manufacture.

One method of manufacturing shoes which is used extensively includes the shaping of the shoe upper by bag-lasting in the “Strobel” method. In the Strobel method a shoe insole is attached to a marginal portion of the shoe upper by sewing, to form a bag. A foot-shaped last is introduced into the thus-formed bag to impart a desired three-dimensional shape to the shoe upper. A sole is then provided for the shoe either by attaching a pre-formed sole unit to the shoe upper and the shoe insole by use of a suitable adhesive, or the sole is applied by injection moulding directly onto the upper/insole. In the lasting process, as the last is forced into the bag, the shoe upper and the insole, and also the stitches securing them together are subjected to considerable force and it is important to ensure that the shoe insole has sufficient tensile strength and stitch-holding capablility.

It is well known to make shoe insoles for the Strobel method using textile based methods, for example using; scrim reinforced needlefelts and a latex binder; stitchbonded fabrics with a latex binder; needlefelts bonded with a bonding fibre and/or latex; stitchbonded fabrics bonded with a bonding fibre; and, spunbonded fabrics bonded with latex or a melt polymer which is co-extruded.

Alternatively, a shoe insole may be formed by an extrusion process combining non-woven fabrics with a polymer sheet; for example, such materials are supplied by the applicant company “Texon” and comprise two polyester needlefelts laminated to a polypropylene-ethylene vinyl acetate sheet where the two polyester needlefelts are further bonded with a latex impregnant as described in International (PCT) patent application no: PCT/GB00/00863.

Insole materials produced from non-woven fibres are typically manufactured by forming a sheet of material by standard non-woven manufacturing techniques and cutting the insoles from the sheet using suitable cutting knives in a well known fashion. Such a technique produces a proportion of scrap laminar material which is difficult to re-use or recycle into itself because it comprises a wide range of materials each having different melting points.

One of the various objects of the present invention is to provide an improved laminar material suitable for use in the manufacture of shoes.

Another of the various objects of the present invention is to provide an improved laminar material which can incorporate scrap (which arises when shoe components are cut from laminar material) back into the new product.

Another of the various objects of the present invention is to provide an improved method of making a shoe insole material in which cutting scrap can be recycled.

According to a first aspect, the present invention provides a laminar material suitable for use in the manufacture of shoes comprising an extruded thermoplastic sheet core having laminated thereto on at least one side a first fibre fabric layer, wherein the melting point of said first fibre layer is similar to the melting point of the thermoplastic sheet core, and the thermoplastic sheet core comprises:

(1) recycled scrap laminar material comprising an extruded thermoplastic material having laminated thereto on at least one side a second fibre fabric layer, wherein the melting points of the extruded thermoplastic material and the second fibre fabric layer are similar to the melting point of the first fibre layer; or

(2) virgin extrudable thermoplastic material having a melting point similar to the melting point of said first fibre layer; or

(3) a mixture of both of these materials (1) and (2).

Preferably, the thermoplastic material of the scrap laminar material is constructed from the same material as the virgin extrudable thermoplastic material.

By the term “similar to” we mean that the melting point of each of the respective fibre fabric layers independently differs from that of the extruded thermoplastic material of the scrap laminar material and the virgin extrudable thermoplastic material by less than 70° C. and preferably by less than 50° C. Most preferably, the respective first or second fibre fabric layer, the extruded thermoplastic material and the virgin extrudable thermoplastic material have substantially the same melting point i.e. the melting points of the respective materials differ by less than 30° C.

As all of the components of the laminated material have comparable melting points, the scrap from the laminated material can be re-melted by standard recycling techniques to produce pellets of polymer, which can be incorporated into the extruded core of the product preferably at levels of between 1% and 60%.

Preferably, a laminar material in accordance with the invention the (or each first and second) fibre fabric layer is a non-woven fabric, preferably a spunbonded fabric of a type well known to those skilled in the art. Preferably, the (or each first and second) fibre fabric layer is made of the same material as the virgin extruded thermoplastic material and/or the extruded thermoplastic material of the scrap laminar material; most preferably all of which are made from polypropylene.

According to an alternative embodiment, the (or each) fibre fabric layer is made of a different material from the virgin extruded thermoplastic material and/or the extruded thermoplastic material of the scrap laminar material. For example, the thermoplastic sheet core may comprise polypropylene whereas the fibre fabric layer may comprise a polyester spunbonded fabric or a bicomponent spunbonded fabric consisting of polypropylene and polyolefin bonding agent.

A preferred laminar material in accordance with the invention has a fibre fabric layer laminated to each side of the thermoplastic core. Preferably, the prepared fibres are of about 5 to 20 decitex.

In a laminar material in accordance with the invention the amount of virgin extrudable thermoplastics material included in the core is sufficient to provide satisfactory melt characteristics for extrusion of the mixture of recycled scrap laminar material and virgin thermoplastic material to provide the thermoplastic core. Preferably, the thermoplastic sheet core comprises 0.1 to 99.9% by weight of virgin extrudable thermoplastic material. For many materials 40% by weight of virgin thermoplastics material is necessary. Although as much virgin thermoplastics material as is necessary may be used in order to provide suitable properties it is desirable to use no more than 60% virgin thermoplastic material for economic and conservational reasons.

In a preferred laminar material in accordance with the invention the material which is granulated to provide the scrap has the same general construction and composition as the laminar material of the present invention. More preferably, the extrudable thermoplastic material and the second fibre layer of the scrap laminar material, and the virgin extrudable thermoplastic material and the first fibre layer of the laminar material of the present invention are all the same material. Preferably, they all comprise greater than 40% by weight of polypropylene. Most preferably, they all comprise 100% by weight polypropylene.

Preferably, in a laminar material in accordance with the invention the virgin thermoplastic material is substantially the same as the extrudable thermoplastics material in the core of the scrap laminar material. In a laminar material in accordance with the invention the core conveniently comprises from 30% to 70% by weight of the total weight of laminar material.

Laminar materials in accordance with the invention may be used in the manufacture of shoe insoles which are also relatively stiff components. Insole materials of appropriate composition may also be recycled and are included in the term “scrap laminar material” where referring to the invention in its broadest aspects.

In another aspect the invention may be considered to provide a method of making a laminar material comprising the steps of:

(i) providing scrap laminar material comprising an extruded thermoplastic material having laminated thereto on at least one side a second fibre fabric layer having a melting point that is similar to the melting point of the extruded thermoplastic material;

(ii) granulating the scrap laminar material;

(iii) melting the granulated scrap laminar material and extruding the molten mixture of scrap material to form a thermoplastic sheet core; and

(iv) laminating a first fibre fabric with the mixture as it is extruded to form the sheet core to provide a fibre fabric layer on at least one surface of the core, wherein the first fibre fabric has a melting point similar to the melting point of the extruded thermoplastic material.

Preferably, the method further includes the step of mixing virgin extrudable thermoplastic material with the granulated scrap laminar material to form a thermoplastic sheet core comprising a mixture of virgin thermoplastic material and scrap material, wherein the melting point of the virgin thermoplastic material is similar to the melting point of the first fibre layer.

According to an alternative embodiment the invention may be considered to provide a method of making a laminar material comprising the steps of:

(i) providing virgin extrudable thermoplastic material;

(ii) melting the virgin thermoplastic material and extruding the molten mixture of virgin thermoplastic material to form a thermoplastic sheet core; and

(iii) laminating a first fibre fabric with the mixture as it is extruded to form the sheet core to provide a fibre fabric layer on at least one surface of the core, wherein the first fibre fabric has a melting point similar to the melting point of the virgin thermoplastic material.

There now follows a detailed description, to be read with reference to the accompanying drawing of a laminar material and a method of making the material. It will be realised that this material and method have been selected for description to illustrate the invention by way of example. It will be appreciated that an insole made of the material embodying the invention may be made by standard cutting techniques well known to a person skilled in the art.

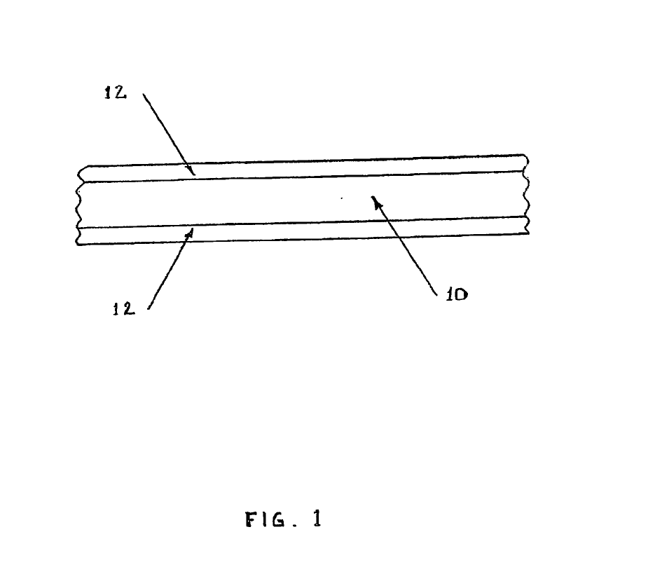

In the accompanying drawing FIG. 1 is a partial view in section of a laminar material embodying the invention.

FIG. 1 shows a laminar material suitable for use in the manufacture of shoes and, especially, suitable for use in the manufacture of insoles. This illustrative material comprises an extruded thermoplastic sheet core 10 having laminated thereto on each side a fibre fabric layer 12.

In the illustrative laminar material the thermoplastic sheet core 10 comprises a mixture of recycled scrap laminar material with virgin extrudable thermoplastic material. The granulated recycled scrap laminar material is cutting scrap produced from a material which is of generally similar construction to the illustrative laminar material but the central thermoplastics core is of virgin polymeric thermoplastics material or recycled material of the present invention. In the virgin scrap material, the polymeric material of the core comprises 100% by weight polypropylene and the virgin extrudable thermoplastic material of the resultant laminar material comprises 100% polypropylene.

In order to produce the illustrative material in carrying out a method in accordance with the invention, the cutting scrap remaining from a sheet of laminar material, following cutting out of shoe insoles, is chopped up in a suitable apparatus, namely an Erema thermoplastic recycling machine which comprises a chopping arrangement in conjunction with an extruder. The scrap is first chopped up without causing the material to overheat. The chopped material is fed directly to a pelletising extruder which supplies the scrap material as a granulate or pellet of a size suitable for use in a plastics sheet extruding apparatus. The scrap granules are then mixed with granules of virgin polymeric thermoplastics material of the same composition as the thermoplastics material in the scrap material, namely polypropylene. The mixed granules (or pellets) are then supplied to the sheet extruder in which they are melted and the melt fully blended and thereafter extruded. The fibre fabric layers are laminated to the extruded thermoplastic sheet core as it leaves the extruder in a manner well known to those skilled in the art.

Although the thermoplastic sheet core of the illustrative laminar material comprises mainly recycled scrap laminar material and virgin polymeric thermoplastics material, other components may be included if desired, for example material commonly included in plastics compounds for extrusion purposes, including fillers, plasticizers and antioxidants and pigments if desired.

The fibre fabric layers 12 of the illustrative laminar material are spunbonded non-woven fibre fabric layers in which the fibre is a polypropylene textile fibre of about 11.0 decitex and is produced by spunbonding techniques in a manner well known to those skilled in the art.

Depending upon the properties required in the final product the weight of the non-woven fibre fabric layers and the gauge of the thermoplastic core may be varied. In the illustrative laminar material each non-woven fibre fabric layer may have a weight of 70 grams per square metre and the extruded core comprises high impact grade polypropylene having a gauge of 0.25 mm.

The scrap laminated material used in the manufacture of the illustrative laminar material has an extruded thermoplastic core of virgin polymeric thermoplastics material having a weight of about 210 grams per square metre and each of the non-woven fibre fabric layers has a weight of about 70 grams per square metre.

The illustrative laminar material is found to be satisfactory for use in the production of shoe insoles and has a performance which is generally comparable with the previously known material where the core is of virgin polymeric material and does not include any scrap laminar material. The accompanying Table 1 gives an indication of the illustrative laminar material having spunbonded fabrics of grade 500S and 700.

TABLE 1

| Test | Specification | 500S | 700 |
|---|---|---|---|
| Weight (gsm) | <480 | 345 | 450 |
| Gauge (mm) | 1.2-1.6 | 0.46 | 0.58 |
| Tear (N) | | | |
| AL | >90 | 79-90 | 68-81 |
| AX | >90 | 85-94 | 123-150 |
| Stitch Tear (N) | | | |
| AL | >80 | 85-88 | 88-93 |
| AX | >80 | 80-102 | 86-90 |
| Tensile (N/cm) | | | |
| AL | >140 | 156-157 | 184-214 |
| AX | >120 | 129-132 | 173-179 |
| Elong. at 100N | | | |
| (%) | | | |
| AL | <2.5 | 1.1-1.1 | 1.0-1.0 |
| AX | <3.0 | 1.0-1.1 | 1.0-1.0 |
| Elong. at Break | | | |
| (%) | | | |
| AL | — | 72-79 | 30-34 |
| AX | — | 37-42 | 33-37 |

1. A laminar material suitable for use in the manufacture of shoes comprising an extruded thermoplastic sheet core having laminated thereto on at least one side a first fibre fabric layer, wherein the melting point of said first fibre layer is similar to the melting point of the thermoplastic sheet core, and the thermoplastic sheet core comprises:
(1) recycled scrap laminar material comprising an extruded thermoplastic material having laminated thereto on at least one side a second fibre fabric layer, wherein the melting points of the extruded thermoplastic material and the second fibre fabric layer are similar to the melting point of the first fibre layer; or
(2) virgin extrudable thermoplastic material having a melting point similar to the melting point of said first fibre layer; or
(3) a mixture of both of these materials (1) and (2).

2. A laminar material according to claim 1 wherein the thermoplastic sheet core comprises 0.1% to 99.9% by weight of virgin extrudable thermoplastic material.

3. A laminar material according to any one of the preceding claims wherein the thermoplastic material of the scrap laminar material has substantially the same melting point as the second fibre fabric layer.

4. A laminar material according to any one of the preceding claims wherein the melting point of the first fibre fabric layer has substantially the same melting point as the virgin extrudable thermoplastics material and/or the thermoplastic material of the scrap laminar material.

5. A laminar material according to any one of the preceding claims wherein the first and/or the second fibre fabric layer is a non-woven fabric.

6. A laminar material according to any one of the preceding claims wherein the first fibre fabric layer is constructed from the same material as the second fibre fabric layer and/or the thermoplastic material of the scrap laminar material and/or the virgin extrudable thermoplastic material.

7. A laminar material according to any one of claims 2 to 6 wherein the thermoplastic material of the scrap laminar material is constructed from the same material as the virgin extrudable thermoplastic material.

8. A laminar material according to any one of the preceding claims wherein the first and second fibre fabric layer are each independently selected from polypropylene and polypropylene-polyethylene copolymer.

9. A laminar material according to any one of the preceding claims wherein the extrudable thermoplastic material is polypropylene.

10. A laminar material according to any one of the preceding claims having a fibre fabric layer laminated to both sides of the thermoplastic core.

11. A laminar material according to any one of claims 1 to 10 wherein the core comprises from 30 to 70% by weight of the total weight of the laminar material.

12. A laminar material according to any one of the preceding claims wherein the recycled scrap laminar material is the same as the laminar material as defined in any one of the preceding claims.

13. A laminar material constructed arranged and adapted to operate substantially as hereinbefore described with reference to the accompanying drawings.

14. A shoe insole including a laminar material according to any one of claims 1 to 13.

15. A method of making a laminar material comprising the steps of:
(i) providing scrap laminar material comprising an extruded thermoplastic material having laminated thereto on at least one side a second fibre fabric layer having a melting point that is similar to the melting point of the extruded thermoplastic material;
(ii) granulating the scrap laminar material;
(iii) melting the granulated scrap laminar material and extruding the molten mixture of scrap material to form a thermoplastic sheet core; and
(iv) laminating a first fibre fabric with the mixture as it is extruded to form the sheet core to provide a fibre fabric layer on at least one surface of the core, wherein the first fibre fabric has a melting point similar to the melting point of the extruded thermoplastic material.

16. A method according to claim 15 further including the step of mixing virgin thermoplastic material with the granulated scrap laminar material to form a thermoplastic sheet core comprising a mixture of virgin thermoplastic material and scrap material, wherein the melting point of the virgin thermoplastic material is similar to the melting point of said first fibre layer.

17. A method according to claim 16 wherein the granulated scrap laminar material is mixed with 0.1% to 99.9% by weight of said virgin thermoplastic material.

18. A method of making a laminar material comprising the steps of:
(i) providing virgin extrudable thermoplastic material;
(ii) melting the virgin thermoplastic material and extruding the molten mixture of virgin thermoplastic material to form a thermoplastic sheet core; and
(iii) laminating a first fibre fabric with the mixture as it is extruded to form the sheet core to provide a fibre fabric layer on at least one surface of the core, wherein the first fibre fabric has a melting point similar to the melting point of the virgin thermoplastic material.

19. A laminar material according to any one of claims 1 to 13 made by a method according to any one of claims 15 to 18.

20. Use of a laminar material as claimed in any one of claims 1 to 13 for making a shoe.
